(19) United States
(12) Patent Application Publication
(10) Pub. No.: US 2025/0214479 A1
(43) Pub. Date: Jul. 3, 2025

(54) REPLACEABLE BATTERY

(71) Applicant: TOYOTA JIDOSHA KABUSHIKI KAISHA, Toyota-shi (JP)

(72) Inventors: Yutaroh GOTOH, Toyota-shi (JP); Kota Nakamura, Toyota-shi (JP); Yukinari TANABE, Okazaki-shi (JP); Taro MATSUSHITA, Toyokawa-shi (JP); Shinnosuke IZUMI, Kitagunma-gun (JP)

(73) Assignee: TOYOTA JIDOSHA KABUSHIKI KAISHA, Toyota-shi (JP)

(21) Appl. No.: 18/956,296

(22) Filed: Nov. 22, 2024

(30) Foreign Application Priority Data
Dec. 27, 2023 (JP) 2023-220266

(51) Int. Cl. B60L 53/80; B60L 50/64; H01M 50/209; H01M 50/249; H01M 50/256; H01M 50/271; H01M 50/296

(52) U.S. Cl. CPC B60L 53/80; H01M 50/209; H01M 50/249; H01M 50/256; H01M 50/271; H01M 50/296; B60L 50/64; H01M 2220/20

(57) ABSTRACT

A replaceable battery according to the present disclosure is a replaceable battery mounted on a vehicle so as to be removable by sliding the replaceable battery in a longitudinal direction, the replaceable battery including: a rectangular parallelepiped cell stack having a plurality of battery cells stacked thereon; and a case for accommodating the cell stack. The case includes a rectangular tube shaped main body part, a first lid part for closing one opening end of the main body part, and a second lid part for closing an other opening end of the main body part. The first lid part is provided with a pull-handle, and the second lid part is provided with a connector protruding outward so as to be connected to a vehicle, and a relief valve through which gas generated from the cell stack is discharged.

### CROSS REFERENCE TO RELATED APPLICATIONS

This application is based upon and claims the benefit of priority from Japanese patent application No. 2023-220266, filed on Dec. 27, 2023, the disclosure of which is incorporated herein in its entirety by reference.

### BACKGROUND

The present disclosure relates to a replaceable battery.

Patent Literature 1 discloses a replaceable battery removably mounted on a vehicle.

Patent Literature 1: Japanese Unexamined Patent Publication No. 2019-169337

### SUMMARY

The inventors have developed a replaceable battery in which a rectangular parallelepiped cell stack is accommodated in a case. A relief valve through which gas is discharged to the outside of the case when gas is generated from the cell stack is provided in the above replaceable battery. If gas is discharged from the relief valve during a battery replacement work, it is necessary to ensure the safety of a worker.

The present disclosure has been made in view of the above-described circumstances, and provides a replaceable battery that ensures the safety of a worker even when gas is discharged from a relief valve during a battery replacement work.

A replaceable battery according to the present disclosure is a replaceable battery mounted on a vehicle so as to be removable by sliding the replaceable battery in a longitudinal direction, the replaceable battery including:
a rectangular parallelepiped cell stack having a plurality of battery cells stacked thereon; and
a case for accommodating the cell stack, in which
the case includes a rectangular tube shaped main body part, a first lid part for closing one opening end of the main body part, and a second lid part for closing an other opening end of the main body part,
the first lid part is provided with a pull-handle, and
the second lid part is provided with a connector protruding outward so as to be connected to a vehicle, and a relief valve through which gas generated from the cell stack is discharged.

In the replaceable battery according to the present disclosure, a first lid part for closing one opening end of a main body part of a case is provided with a pull-handle, and a second lid part for closing the other opening end of the main body part is provided with a connector protruding outward so as to be connected to a vehicle and a relief valve through which gas generated from the cell stack is discharged.

When a worker replaces the battery, the worker works on the side of the first lid part provided with a pull-handle. Even if gas is discharged from the relief valve during the battery replacement work, the relief valve is provided in the second lid part located via the battery on the side of an area opposite to an area where the worker is present, and the gas is discharged toward the area opposite to the area where the worker is present, so that the safety of the worker can be ensured.

The relief valve may be provided in an upper edge of the second lid part. By this configuration, gas generated from the cell stack can be efficiently discharged from a spatial area on the cell stack through the relief valve.

A side surface of the connector may be covered with a cylindrical cover made of metal. By this configuration, even if gas is discharged from the relief valve, the connector can be protected by the cover made of metal.

The first lid part may be provided so that it presses the one opening end of the main body part from an outer side thereof. By this configuration, it is possible to, before gas is discharged through the relief valve provided in the second lid part, reduce the number of occurrences of leakage of the gas from the side of the first lid part where a worker is working.

A grip-handle may be provided in a central part of the upper edge of the second lid part, and the grip-handle may be placed on an upper surface of the main body part so as to be rotatable around a shaft extending along an upper edge of the second lid part. By this configuration, the replaceable battery can be carried by use of a grip-handle without interrupting the connection of a connector.

A rib groove may extend in a longitudinal direction of the main body part on the upper surface of the main body part, and the grip-handle may be accommodated in the rib groove in a state in which it is placed on the upper surface of the main body part. This configuration makes it easy to accommodate the replaceable battery in the storage space for the replaceable battery.

The main body part may be formed of a first member including a first side plate and a bottom plate for supporting the cell stack, the first member having an L-shaped cross section, and a second member including a second side plate and a top plate on which the grip-handle is placed, the second member having an L-shaped cross section. This configuration makes it easy to accommodate an object to be accommodated, such as a cell stack, in the case during assembly, so that the workability of the assembly is improved.

The cell stack may be disposed so as to be closer to the first side plate than to the second side plate. Even when a worker carries the replaceable battery in which the center of gravity thereof is shifted to one side as described above, the worker can hold a rotatable grip-handle with one hand and lift the replaceable battery and at the same time support the replaceable battery with the other hand. Therefore, the worker can carry the replaceable battery while keeping balance.

According to the present disclosure, it is possible to provide a replaceable battery that ensures the safety of a worker even when gas is discharged from a relief valve during a battery replacement work.

The above and other objects, features and advantages of the present disclosure will become more fully understood from the detailed description given hereinbelow and the accompanying drawings.

### BRIEF DESCRIPTION OF DRAWINGS

FIG. 1 is a schematic perspective view showing an external appearance of a replaceable battery according to a first embodiment;

FIG. 2 is an enlarged schematic perspective view of the periphery of a front case provided at the front end of the replaceable battery according to the first embodiment;

FIG. 3 is an enlarged schematic perspective view of the periphery of a rear case provided at the rear end of the replaceable battery according to the first embodiment;

FIG. 4 is a schematic perspective view showing a modified example of a grip-handle 131;

FIG. 5 is a flowchart showing a flow of assembly of the replaceable battery according to the first embodiment;

FIG. 6 is a schematic perspective view for explaining the flow of assembly of the replaceable battery according to the first embodiment;

FIG. 7 is a schematic perspective view for explaining the flow of assembly of the replaceable battery according to the first embodiment; and

FIG. 8 is a schematic cross-sectional view of the replaceable battery according to the first embodiment.

### DESCRIPTION OF EMBODIMENTS

The present disclosure will be described hereinafter through embodiments of the present disclosure. However, the disclosure according to the claims is not limited to the following embodiments. Further, all the components/structures described in the embodiments are not necessarily essential as means for solving the problem. For the clarification of the description, the following descriptions and the drawings are partially omitted and simplified as appropriate. The same elements are denoted by the same reference numerals or symbols throughout the drawings, and redundant descriptions are omitted as necessary.

### First Embodiment

### Configuration of Replaceable battery 1

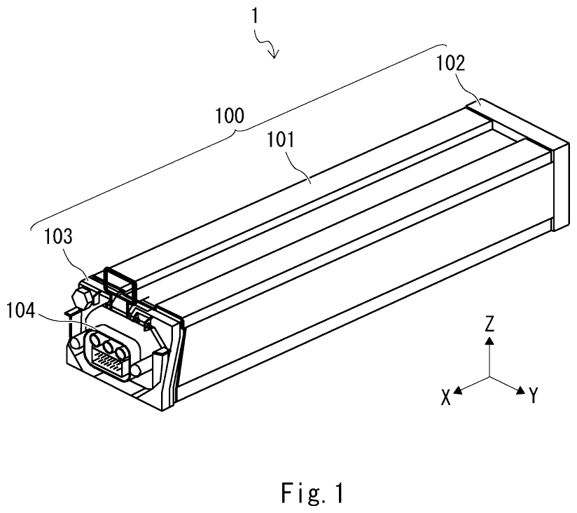

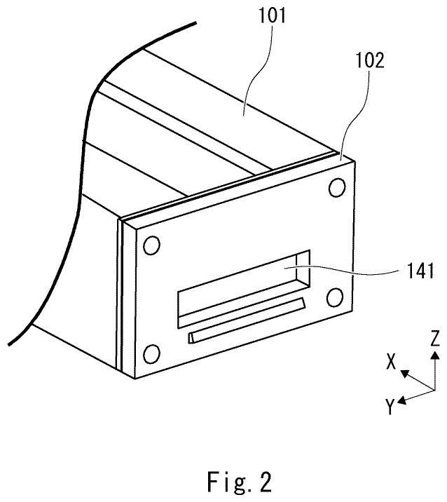

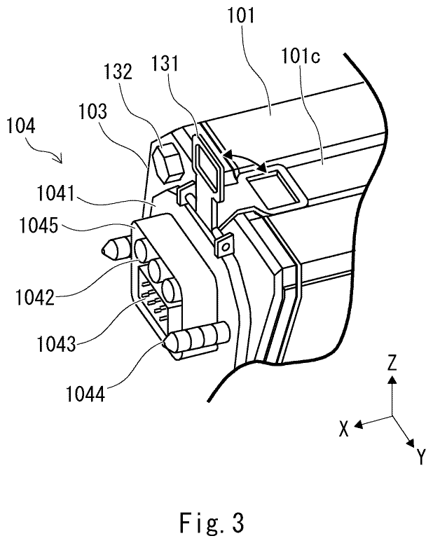

First, a configuration of a replaceable battery 1 according to a first embodiment will be described with reference to FIGS. 1 to 3. FIG. 1 is a schematic perspective view showing an external appearance of the replaceable battery 1 according to the first embodiment. FIG. 2 is an enlarged schematic perspective view of the periphery of a front case provided at the front end of the replaceable battery according to the first embodiment. FIG. 3 is an enlarged schematic perspective view of the periphery of a rear case provided at the rear end of the replaceable battery according to the first embodiment.

The replaceable battery 1 is also referred to as a battery pack, a battery module, or the like, and is removably mounted on a vehicle such as a battery electric vehicle driven by a motor using electricity as a power source. The size and the weight of the replaceable battery 1 are reduced so that, for example, a worker (including a work robot and the like) can easily insert and remove the replaceable battery 1 into and from a battery electric vehicle.

Note that it is needless to say that right-handed XYZ orthogonal coordinates shown in FIGS. 1 to 3 are shown only for the sake of convenience to explain positional relations among the components. Normally, in FIG. 1 etc., the Z-axis positive direction is a vertically upward direction, and the XY plane is a horizontal plane, which direction and plane are the same throughout the drawings.

As shown in FIG. 1, in the replaceable battery 1, the outer shape of a rectangular parallelepiped shape is defined by a case 100 for accommodating a cell stack and the like. The case 100 includes a case main body (a main body part) 101 having a rectangular tube shape, a front case 102 serving as a lid part for closing one opening end of the case main body 101 (an opening part of the case main body 101 at the front end thereof), and a rear case 103 serving as a lid part for closing the other opening end of the case main body 101 (an opening part of the case main body 101 at the rear end thereof).

Further, a connector 104 formed so that it protrudes outward so as to be connectable to a connector on the vehicle side is provided in the rear case 103 that is provided at the rear end of the replaceable battery 1.

Although not shown, for example, a worker accommodates the replaceable battery 1 in the storage space of the vehicle while sliding the replaceable battery 1 in the longitudinal direction (the X-axis direction), whereby the connector 104 of the replaceable battery 1 is connected to the connector on the vehicle side.

As shown in FIG. 2, a pull-handle 141 for sliding the replaceable battery 1 is provided in the front case (first lid part) 102. The pull-handle 141 shown in FIG. 2 is a recessed pull-handle. However, it is not limited to a particular kind of handle. A worker can slide the replaceable battery 1 by holding the pull-handle 141 and then pushing or pulling the replaceable battery 1.

Further, the replaceable battery 1 can be placed on, for example, a carriage and then transferred. When the replaceable battery 1 is taken out of the carriage so as to be accommodated in the storage space, the height of the carriage is adjusted to that of the storage space and the pull-handle 141 is pushed, so that the replaceable battery 1 is accommodated in (i.e., slid into) the storage space. On the other hand, when the replaceable battery 1 is taken out of the storage space so as to be placed on the carriage, the height of the carriage is adjusted to that of the storage space and the pull-handle 141 is pulled, so that the replaceable battery 1 is taken out of the storage space.

As shown in FIG. 3, in addition to the connector 104, a grip-handle 131 and a relief valve 132 are provided in the rear case (second lid part) 103. Note that the connector 104 includes a base 1041, a high-voltage terminal 1042, a low-voltage terminal 1043, a pin 1044 for alignment, and a cover 1045 made of metal.

The base 1041 is disposed in the main surface of the rear case 103.

All of the high-voltage terminal 1042, the low-voltage terminal 1043, and the pin 1044 for alignment are formed so that they protrude outward from the main surface of the base 1041.

The cover 1045 is formed so that it surrounds the side surfaces of the high-voltage terminal 1042 and the low-voltage terminal 1043.

The high-voltage terminal 1042 is a terminal for transmitting electricity output from a cell stack accommodated in the case 100 of the replaceable battery 1 to a vehicle on which the replaceable battery 1 is mounted.

The low-voltage terminal 1043 is a terminal for transmitting a control signal from a vehicle to the replaceable battery 1, and for transmitting a signal indicative of a result of monitoring of a cell stack (a result of a voltage measurement etc.) from the replaceable battery 1 to a vehicle.

As shown in FIG. 3, the grip-handle 131 is provided rotatably around a shaft extending along the upper edge of the rear case 103, and is placed on an upper surface of the case main body 101 (i.e., an upper surface of the top plate) when not in use. Therefore, the replaceable battery 1 can be carried by use of the grip-handle 131 without interrupting the connection of the connector 104.

More specifically, when a worker carries the replaceable battery 1, the worker holds the rotatable grip-handle 131 with one hand and lifts the replaceable battery 1, and at the same time holds, for example, the pull-handle 141 with the other hand and supports the replaceable battery 1. Therefore, the worker can carry the replaceable battery 1 while keeping balance.

The grip-handle 131 shown in FIG. 3 is a single plate-like member. However, the present disclosure is not limited to a particular kind of member. As shown in FIG. 3, a base part of the grip-handle 131 is provided rotatably around a shaft extending along an upper edge of the rear case 103. A rectangular opening part is provided in a tip part of the grip-handle 131. A worker inserts his/her finger into the opening part, holds the grip-handle 131, and lifts the replaceable battery 1.

As shown in FIG. 3, a rib groove 101c is formed on the upper surface of the case main body 101 (i.e., the upper surface of the top plate) along the longitudinal direction (the X-axis direction) of the case main body 101 so that the plate-like grip-handle 131 can be accommodated in the rib groove 101c when not in use. Thus, a worker can easily accommodate the replaceable battery 1 in the storage space of a vehicle. Further, the strength of the upper surface of the case main body 101 is improved as well by forming the rib groove 101c on the upper surface thereon.

Note that the thickness of the case main body 101 is preferably reduced, and the thickness of the rear case 103 is preferably larger than the thickness of the case main body 101. For example, a die-cast member is used as the rear case 103. This configuration improves the rigidity of the rear case 103, and also improves the workability when the grip-handle 131 is used. Further, it is possible to reduce the number of occurrences of deformation of the case 100 by providing the grip-handle 131 in the rear case 103 having a large thickness.

On the contrary, it is possible to reduce the weight of the case 100 by reducing the thickness of the case main body 101. Further, if gas is generated in a cell stack 110, the case main body 101 becomes deformed and swells outward, so that a sudden increase in the internal pressure of the case 100 can be suppressed.

The relief valve 132 discharges gas generated in the cell stack accommodated in the case 100 of the replaceable battery 1. As shown in FIG. 3, since the grip-handle 131 is provided in the central part of the upper edge of the rear case 103, the relief valve 132 is provided in the corner of the upper edge of the rear case 103.

Note that, in FIG. 3, the relief valve 132 is provided in the corner of the upper edge of the rear case 103 on the Y-axis negative direction side. However, it may instead be provided in the corner of the upper edge of the rear case 103 on the Y-axis positive direction side.

Note that, when a worker replaces the replaceable battery 1, the worker works on the side of the front case 102 provided with the pull-handle 141. Even if gas is discharged from the relief valve 132 during work for replacing the replaceable battery 1, the relief valve 132 is provided in the rear case 103 located via the replaceable battery 1 on the side of an area opposite to an area where a worker is present, and the gas is discharged toward the area opposite to the area where the worker is present. Therefore, the safety of the worker can be ensured. When the worker is a work robot or the like, adverse effects due to gas can be reduced.

Further, even if gas is discharged from the relief valve 132 when a worker is carrying the replaceable battery 1 while holding the grip-handle 131 and the pull-handle 141, the gas is not discharged toward the worker. Therefore, the safety of the worker can be ensured.

Further, even when gas is discharged from the relief valve 132, the high-voltage terminal 1042 and the low-voltage terminal 1043 can be protected by the cover 1045 made of metal. Although a plastic cover has a risk of being melted and damaged by gas, the metal cover 1045 has no risk of being melted and damaged. Further, the metal cover 1045 has excellent durability, and as a result of this, it can be advantageously used, since the connector 104 is repeatedly inserted into and removed from the connector on the vehicle side.

Although not shown, in a wall surface that faces the rear case 103 in the storage space of the vehicle in which the replaceable battery 1 is accommodated, an exhaust port through which gas discharged through the relief valve 132 is discharged to the outside via the vehicle is provided. The gas discharged from the relief valve 132 is discharged to the outside of the vehicle, for example, from the lower side of the vehicle through a duct connected to the exhaust port.

Therefore, even if gas is discharged from the relief valve 132 in a state in which the replaceable battery 1 is accommodated in the storage space of the vehicle, the gas does not flow to an area where a worker is present, and thus the safety of the worker can be ensured.

### Modified Example of Grip-handle 131

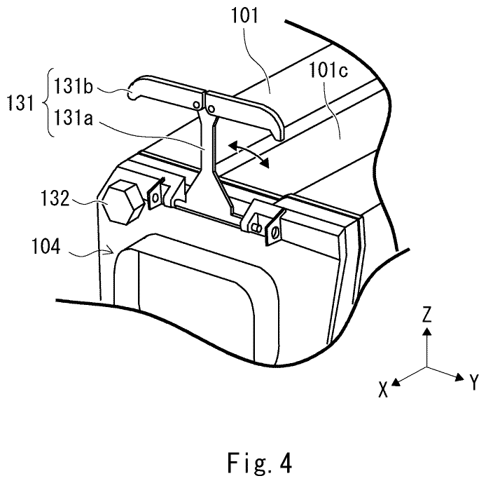

A modified example of the grip-handle 131 will be described below with reference to FIG. 4. FIG. 4 is a schematic perspective view showing the modified example of the grip-handle 131.

As shown in FIG. 4, the grip-handle 131 according to the modified example includes a support part 131a and a pair of grip parts 131b. The base part of the plate-like support part 131a is provided rotatably around a shaft extending along the upper edge of the rear case 103. Further, the base parts of the pair of grip parts 131b are rotatably connected to the tip part of the support part 131a. Therefore, in the grip-handle 131 according to the modified example shown in FIG. 4, the pair of grip parts 131b can be folded.

Although not shown, when the pair of grip parts 131b are not in use, the longitudinal direction thereof is parallel to the longitudinal direction of the support part 131a, and the pair of grip parts 131b are folded. In this state, the grip-handle 131 is placed on the upper surface of the case main body 101.

On the other hand, when the pair of grip parts 131b are in use, as shown in FIG. 4, they are opened until they form a straight line by rotating them about 90 degrees so that they are spaced apart from each other. As a result, as shown in FIG. 4, the grip-handle 131 is formed into a T-shape as a whole. A worker then grips the pair of grip parts 131b which are opened so as to form a straight line.

Note that, in the grip-handle 131 shown in FIG. 4, the width of the tip part of the support part 131a is smaller than the width of the base part of the support part 131a. However, the width of the tip part of the support part 131a is not limited to a particular width, and may be equal to the width of the base part of the support part 131a.

### Assembly of Replaceable battery 1

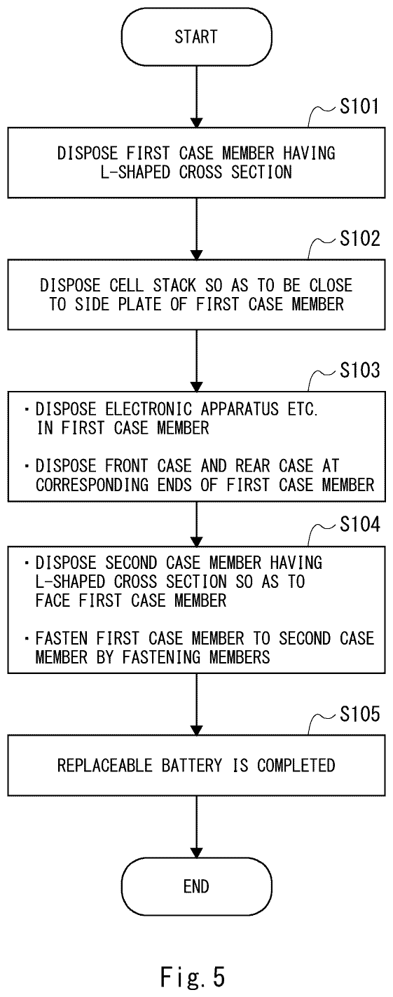

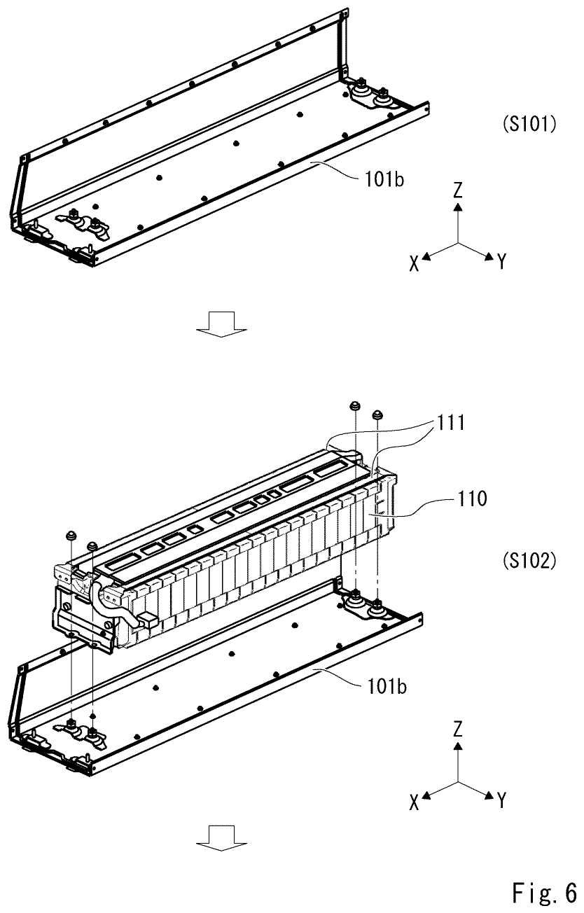

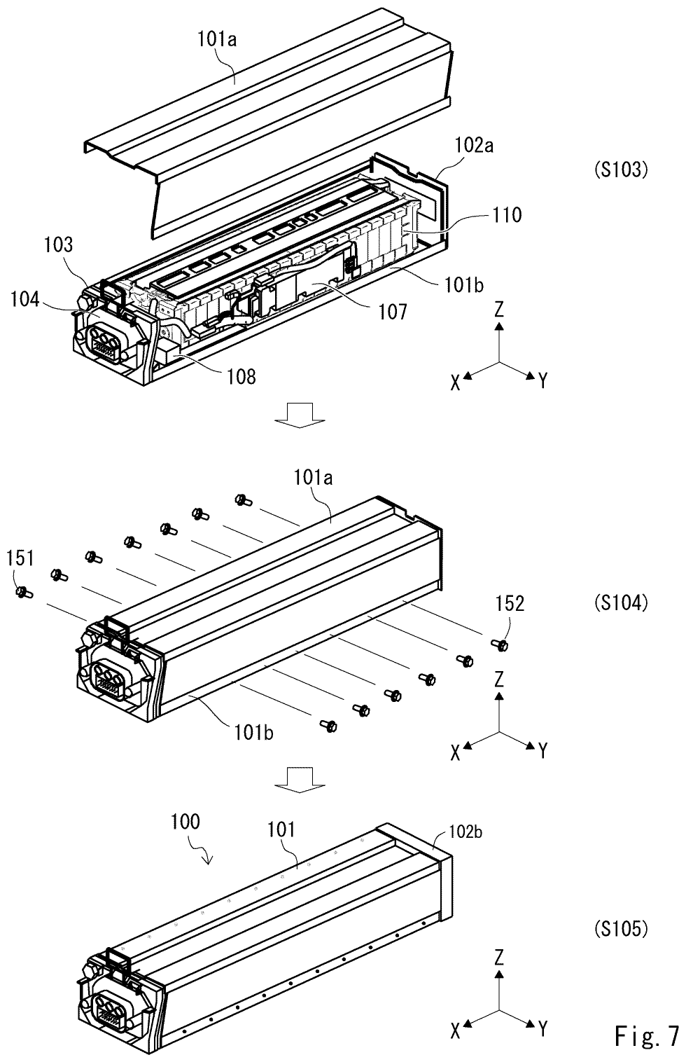

Next, referring to FIGS. 5 to 7, an object to be accommodated in the case 100 of the replaceable battery 1 and assembly of the replaceable battery 1 will be described together. FIG. 5 is a flowchart showing the assembly of the replaceable battery 1. FIGS. 6 and 7 are schematic perspective views for explaining a flow of the assembly of the replaceable battery 1. The diagrams of Steps S101 to S105 shown in FIGS. 6 and 7 correspond to results of the processes of Steps S101 to S105 shown in FIG. 5, respectively.

First, a lower case (a second member) 101b forming a bottom plate of the case main body 101 and one side plate (a second side plate) is disposed (Step S101). The lower case 101b is formed so that the YZ cross section thereof has an L-shape and so that it extends along the X-axis direction.

Then, the rectangular parallelepiped cell stack 110 is disposed on the upper side of the bottom plate formed by the lower case 101b so as to be close to one side plate formed by the lower case 101b (Step S102). The cell stack 110 is formed by stacking a plurality of battery cells, and is bound so as to have a rectangular parallelepiped shape by a binding member 111 such as a binding band.

Then, electronic apparatuses such as a junction box 108 including a relay and the like and a battery monitoring apparatus 107 are further disposed on the upper side of the bottom plate formed by the lower case 101b (Step S103). The battery monitoring apparatus 107 includes a voltage measurement apparatus that measures the voltage of the cell stack 110, the voltage of each of the battery cells forming the cell stack, and so on. In the upper-side area of the bottom plate formed by the lower case 101b, the battery monitoring apparatus 107 is disposed in a spatial area between the cell stack 110 and the other side plate of the case main body 101 described later. This spatial area is formed by disposing the cell stack 110 so as to be close to one side plate of the case main body 101. The junction box 108 is disposed in a spatial area between the rear end of the cell stack 110 and the rear case 103 described later.

Further, an inner-side case 102a of the front case 102 is disposed at a front end of the lower case 101b (the case main body 101) (Step S103). The rear case 103 including the connector 104 is disposed at a rear end of the lower case 101b (the case main body 101) (Step S103).

Then, an upper case (a first member) 101a forming the top plate and the side plate (a first side plate) of the case main body 101 is disposed so as to face the lower case 101b (Step S104). The upper case 101a is formed so that the YZ cross section thereof has an L-shape and so that it extends along the X-axis direction. The case main body 101 having a rectangular tube shape is formed of the upper case 101a and the lower case 101b.

A spatial area 160 is provided above the cell stack 110 in the internal area of the case main body 101. The spatial area 160 is also used as a smoke exhaust area from which gas generated in the cell stack 110 is released. For example, gas generated in the cell stack 110 is discharged from the spatial area 160 to the outside of the case 100 through the relief valve 132. Since the relief valve 132 is provided at the upper edge of the rear case 103, gas generated from the cell stack 110 can be efficiently discharged from the spatial area 160 on the cell stack 110 through the relief valve 132.

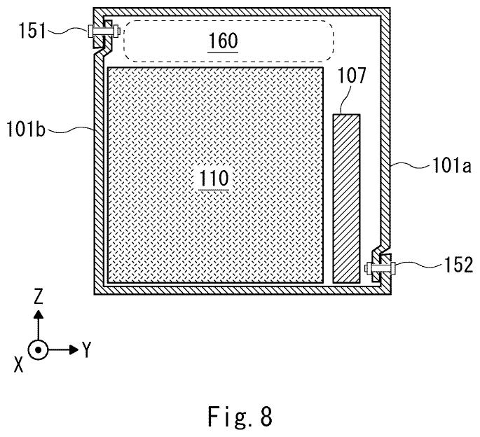

Further, the upper case 101a is fastened to the lower case 101b by fastening members 151 and 152 (Step S104). FIG. 8 is a schematic cross-sectional view of the replaceable battery 1. As shown in FIG. 8, an end of one side plate formed by the lower case 101b that protrudes from the spatial area 160 is fastened to an end of the top plate formed by the upper case 101a by the fastening member 151. Further, an end of the other side plate formed by the upper case 101a is fastened to an end of the bottom plate formed by the lower case 101b by the fastening member 152.

By the above configuration, the cell stack 110 can be disposed so as to be close to one side plate formed by the lower case 101b without being subject to interference of the fastening member 151. As a result, for example, a spatial area sufficiently large enough for the battery monitoring apparatus 107 to be disposed therein can be secured between the cell stack 110 and the other side plate formed by the upper case 101a.

Then, an outer-side case 102b of the front case 102 is disposed at the front end of the case main body 101. In this way, the replaceable battery 1 is completed (Step S105). The outer-side case 102b has a cap-like shape, and is attached to the front end of the case main body 101 so that it covers the opening part (the opening end) of the case main body 101 at the front end thereof together with the side surfaces of the case main body 101. By this configuration, it is possible to, before gas is discharged through the relief valve 132, reduce the number of occurrences of leakage of the gas from the side of the front case 102 where a worker is working.

As described above, in the replaceable battery 1 according to the present disclosure, the connector 104 protruding outward so as to be connected to a vehicle and the grip-handle 131 for lifting the replaceable battery 1 are provided in the rear case 103 that closes the opening end of the case main body 101. Further, the grip-handle 131 is provided rotatably around a shaft extending along the upper edge of the rear case 103, and is placed on the upper surface of the case main body 101 when not in use.

Therefore, it is possible to provide a replaceable battery that can be carried by use of the grip-handle 131 without interrupting the connection of the connector.

Further, in the replaceable battery 1 according to this embodiment, the cell stack having a large mass is disposed so as to be close to one side plate in the case 100. That is, when a worker carries the replaceable battery 1, the worker may lose balance since the center of gravity thereof is shifted to one side. On the other hand, in the replaceable battery 1 according to the present disclosure, when a worker carries the replaceable battery 1, the worker can hold the rotatable grip-handle 131 with one hand and lift the replaceable battery 1, and at the same time hold, for example, the pull-handle 141 with the other hand and support the replaceable battery 1. Therefore, the worker can carry the replaceable battery 1 while keeping balance.

Note that the cell stack does not need to be disposed in the case 100 so as to be close to one side plate, and may instead be disposed in the center of the case 100.

Further, in the replaceable battery according to the present disclosure, the case main body 101 is formed of a pair of the upper case 101a and the lower case 101b each having an L-shaped cross section, and thus an object to be accommodated, such as a cell stack, can be easily accommodated in the case during assembly. That is, by the replaceable battery according to the present disclosure, it is possible to improve workability during assembly.

Note that the case main body 101 does not need to be formed of a pair of the upper case 101a and the lower case 101b each having an L-shaped cross section. For example, the case main body 101 may be formed of an upper case having a U-shaped cross section and a lower case having a flat plate shape, or may be a single cylindrical member.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A replaceable battery mounted on a vehicle so as to be removable by sliding the replaceable battery in a longitudinal direction, the replaceable battery comprising:
a rectangular parallelepiped cell stack having a plurality of battery cells stacked thereon; and
a case for accommodating the cell stack, wherein
the case comprises a rectangular tube shaped main body part, a first lid part for closing one opening end of the main body part, and a second lid part for closing an other opening end of the main body part,
the first lid part is provided with a pull-handle, and
the second lid part is provided with a connector protruding outward so as to be connected to a vehicle, and a relief valve through which gas generated from the cell stack is discharged.

2. The replaceable battery according to claim 1, wherein the relief valve is provided in an upper edge of the second lid part.

3. The replaceable battery according to claim 1, wherein a side surface of the connector is covered with a cylindrical cover made of metal.

4. The replaceable battery according to claim 1, wherein the first lid part is provided so that it presses the one opening end of the main body part from an outer side thereof.

5. The replaceable battery according to claim 1, wherein
a grip-handle is provided in a central part of the upper edge of the second lid part, and
the grip-handle is placed on an upper surface of the main body part so as to be rotatable around a shaft extending along an upper edge of the second lid part.

6. The replaceable battery according to claim 5, wherein
a rib groove extends in a longitudinal direction of the main body part on the upper surface of the main body part, and
the grip-handle is accommodated in the rib groove in a state in which it is placed on the upper surface of the main body part.

7. The replaceable battery according to claim 5, wherein
the main body part is formed of
a first member comprising a first side plate and a bottom plate for supporting the cell stack, the first member having an L-shaped cross section, and
a second member comprising a second side plate and a top plate on which the grip-handle is placed, the second member having an L-shaped cross section.

8. The replaceable battery according to claim 7, wherein the cell stack is disposed so as to be closer to the first side plate than to the second side plate.
